(19) United States
(12) Patent Application Publication
(10) Pub. No.: US 2013/0282444 A1
(43) Pub. Date: Oct. 24, 2013

(54) METHOD AND APPARATUS FOR USING A CUSTOMIZABLE GAME-ENVIRONMENT TO EXTRACT BUSINESS INFORMATION TO RECOMMEND A MARKETING CAMPAIGN

(71) Applicants: JONAS KARLSSON, Rochester, NY (US); Julianna Lin, San Jose, CA (US)

(72) Inventors: JONAS KARLSSON, Rochester, NY (US); Julianna Lin, San Jose, CA (US)

(73) Assignee: Xerox Corporation, Norwalk, CT (US)

(21) Appl. No.: 13/453,271

(22) Filed: Apr. 23, 2012

(51) Int. Cl. G06Q 10/06

(52) U.S. Cl. 705/7.37

(57) ABSTRACT

A method, non-transitory computer readable medium, and apparatus for recommending a marketing campaign for a business are disclosed. For example, the method receives one or more parameters of the business and a business objective, generates a game-environment of the business based upon the one or more parameters, simulates an operation of the business in the game-environment using the one or more parameters and recommends a marketing campaign for the business based upon the operation of the business that is simulated and meeting the business objective.

The present disclosure relates generally to extracting business information and, more particularly, to a method and apparatus for using a customizable game-environment to extract business information and make a marketing campaign recommendation.

### BACKGROUND

Many businesses attempt to use marketing to help promote their business and generate more revenue. Some businesses look for help in determining what marketing strategies to deploy.

Currently used methods require the business owners to answer a long list of specific questions to help formulate a marketing strategy. The tedium of these approaches can lead to inaccurate or incomplete information if the business owner provides the information hastily or avoids the process completely. In addition, these types of methods may be rigid in that it does not account for changes or other modifications to the business on-the-fly and adjust the marketing strategy accordingly.

### SUMMARY

According to aspects illustrated herein, there are provided a method, a non-transitory computer readable medium, and an apparatus for recommending a marketing campaign for a business. One disclosed feature of the embodiments is a method that receives one or more parameters of the business and a business objective, generates a game-environment of the business based upon the one or more parameters, simulates an operation of the business in the game-environment using the one or more parameters and recommends a marketing campaign for the business based upon the operation of the business that is simulated and meeting the business objective.

Another disclosed feature of the embodiments is a non-transitory computer-readable medium having stored thereon a plurality of instructions, the plurality of instructions including instructions which, when executed by a processor, cause the processor to perform a method that receives one or more parameters of the business and a business objective, generates a game-environment of the business based upon the one or more parameters, simulates an operation of the business in the game-environment using the one or more parameters and recommends a marketing campaign for the business based upon the operation of the business that is simulated and meeting the business objective.

Another disclosed feature of the embodiments is an apparatus comprising a processor that is configured to receive one or more parameters of the business and a business objective, generate a game-environment of the business based upon the one or more parameters, simulate an operation of the business in the game-environment using the one or more parameters and recommend a marketing campaign for the business based upon the operation of the business that is simulated and meeting the business objective.

### BRIEF DESCRIPTION OF THE DRAWINGS

The teaching of the present disclosure can be readily understood by considering the following detailed description in conjunction with the accompanying drawings, in which:

FIG. 1 illustrates one example of a communication network of the present disclosure;

FIG. 2 illustrates an example graphical user interface of the present disclosure;

FIG. 3 illustrates an example flowchart of one embodiment of a method for recommending a marketing campaign for a business; and

FIG. 4 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present disclosure broadly discloses a method and non-transitory computer readable medium for recommending a marketing campaign for a business. As discussed above, currently used methods to collect information about a business to formulate a marketing campaign for the business are tedious. This leads to inaccurate or incomplete information and does not provide the flexibility to adapt the marketing campaign on-the-fly to respond to changes that occur in the business.

Thus, an embodiment of the present disclosure provides a way to collect information from a user or a business owner in a more “fun” way that leads to recommendations for marketing campaigns that are specifically tailored for a particular business. In addition, the embodiment of the present disclosure provides feedback to changes in the business quickly and can quickly adapt the recommended marketing campaign based upon the changes.

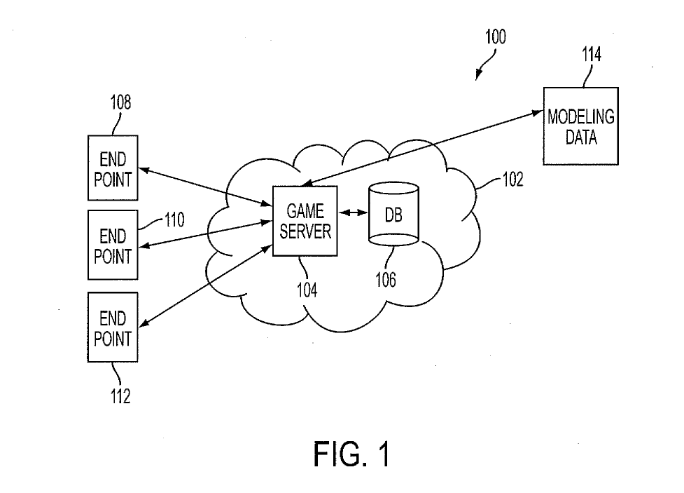

To better understand the present disclosure, FIG. 1 illustrates an example of a communication network 100. In one embodiment, the communication network 100 includes a packet network such as an Internet Protocol (IP) network 102. The IP network 102 may be, for example, the Internet, a service provider network, an access network, a core network, a local area network, and the like.

In one embodiment, the IP network 102 may include a game server 104 and a database (DB) 106. Although the game server 104 and the DB 106 are illustrated as separate hardware components in the IP network 102, it should be noted that functions of the game server 104 and the DB 106 may be incorporated into a single piece of hardware, such as a general application server in the IP network 102. In addition, although the game server 104 and the DB 106 are illustrated as being co-located in the same IP network 102, it should be noted that the game server 104 and the DB 106 may be placed in different locations in one or more different IP networks 102.

In one embodiment, one or more endpoint devices 108, 110 and 112 may be in communication with the IP network 102. The one or more endpoint devices 108, 110 and 112 may be modified to include a client that operates with the game server 104 and displays a graphical user interface discussed below. In one embodiment, the one or more endpoint devices 108, 110 and 112 may be any device capable of communicating with and interacting with the game server 104, such as for example, a personal computer, a lap top computer, a tablet device, a smartphone, a cellular phone, a netbook, and the like. Although three endpoint devices 108, 110 and 112 are illustrated in FIG. 1, it should be noted that any number of endpoint devices may be deployed.

In one embodiment, the game server 104 may include processing hardware such as processors and memory necessary to generate a game-environment and to graphically simulate operation of the business using one or more parameters that are received from the user. The game server may perform calculations that are needed for the game-environment, such as for example, profit, customers per hour, costs, how many customers are reached, how many customers take action, sales, revenue, a score, and the like. In addition, the game server may track a leaderboard of all users that are competing with one another in a particular business simulation.

In one embodiment, the game server 104 may include a simulation engine that may simulate operation of the business using one or more models. The models provide information with respect to how customers may behave or respond to a particular type of marketing campaign. For example, a model for a mass mailing marketing campaign may find that a mass mailing marketing campaign may reach 20,000 people in a geographic region, that 5%, or 1000 people, of this group will take some action in the form of visiting the store or visiting a website of the store and that 1%, or 100 people, of this group will actually make a purchase. The model may also provide information such as, for example, of the 100 people that make a purchase in response to the mass mailing, the average purchase is approximately $100 per visit. This information may then be used by the simulation engine to simulate based upon product information, sales price of the product, cost of the mass mailing marketing campaign, and other similar information provided by a user, how many customers would visit the store, how many customers would make a purchase, the amount of profit and revenue that would be generated, and the like. In other words, the modeling data can be combined with information about the products or services sold by the business to project sales figures and other related data that may be displayed to a user via a simulation in a game-environment.

One specific example of a model that can be used includes short and long term Return on Marketing Investment (ROMI) that may simulate the financial impact to the business of various marketing approaches and outcomes. The models may compute ROMI for various behavior and response outcomes of marketing campaigns.

The short term ROMI, may be used as a simple index measuring the dollars of revenue (or market share, contribution margin or other desired outputs) for every dollar of marketing spent. For example, if a company spends $100,000 on a direct mail piece and it delivers $500,000 in incremental revenue then the ROMI factor is 5.0. If the incremental contribution margin for that $500,000 in revenue is 60%, then the margin ROMI (the amount of incremental margin for each dollar of marketing spent is 3.0 (e.g., 5.0×60%=3.0). The value of the first ROMI is in its simplicity. In most cases, a simple determination of revenue per dollar spent for each marketing activity can be sufficient enough to help make important decisions to improve the entire marketing mix.

In a similar way, the long term ROMI can be used to determine other less tangible aspects of marketing effectiveness. Although one example of a model used by a simulation engine to simulate operation of a business is provided, it should be noted that other models may be used.

In one embodiment, the DB 106 may store various parameters associated with the business provided by the user or the business owner. For example, the parameters may include an initial marketing campaign, business specific information (e.g., a name of the company, costs, what products and/or services are sold, profit data, revenue data or profit margin data), product/service specific information (e.g., a name of each product and/or service, a level of inventory for each product, a lead time for each product and/or service or profit for each product sold), and/or customer profile information (e.g., average age of a typical customer, gender of a typical customer or ethnicity of a typical customer). The above listed categories of information are only a few examples and should not be considered limiting.

In one embodiment, the DB 106 may also store the various types of marketing campaigns that may be deployed and the associated information. For example, the marketing campaigns may include mass mailings, coupon offers, email campaigns, personalization, personal universal resource locators (PURL), response tracking, and the like. Each marketing campaign may have data associated with it, for example, an expected percentage of customers that will respond to the type of marketing campaign, an expected percentage of customers that will make a purchase in response to the type of marketing campaign, an expected percentage of customers that will visit a store or a website in response to the type of marketing campaign, and the like.

In one embodiment, the information associated with the various marketing campaigns may be obtained and stored in the DB 106 via customer surveys that are sent out and collected by the business or a third party. In another embodiment, the information associated with the various marketing campaigns may be obtained from a third party source, e.g., modeling data 114. For example, a third party may have collected information and statistics on a certain type of marketing campaign. Thus, the game server 104 may search or crawl the Internet for the modeling data 114 associated with a particular marketing campaign such that the game server 104 may use the modeling data 114 to perform the necessary calculations in the simulation.

It should be noted that the network 100 has been simplified for clarity. For example, the network 100 may include other network elements such as border elements, routers, switches, policy servers, security devices, firewalls, a content distribution network (CDN) and the like. In addition, the network 100 may include additional networks between the endpoint devices and the IP network 102 such as different access networks (e.g., a wired access network, a cable network, a wireless network, a cellular network, a Wi-Fi network, and the like) to reach the IP network 102.

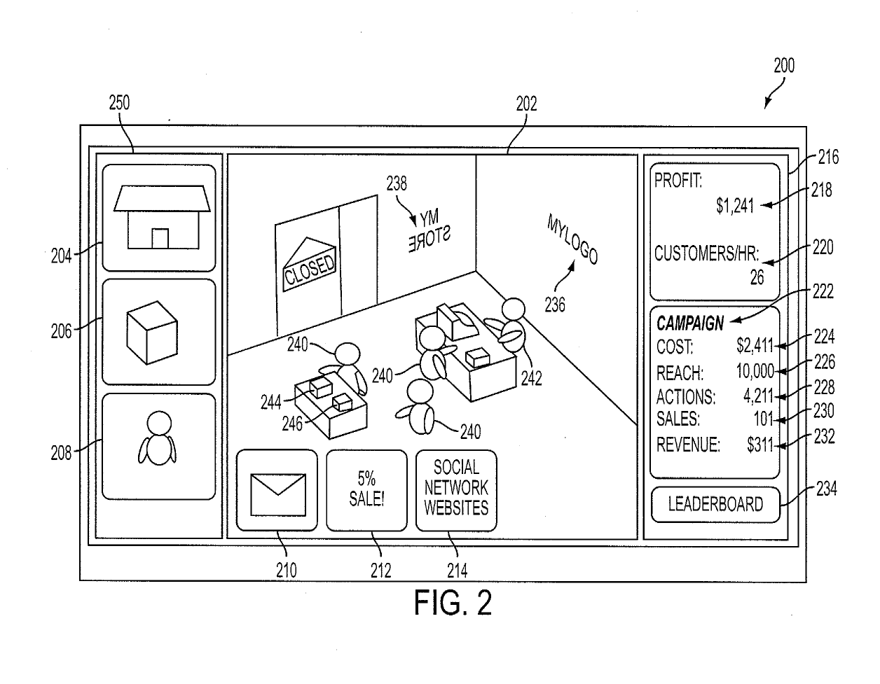

FIG. 2 illustrates an example graphical user interface (GUI) 200 of one embodiment of a game-environment 202 of the present disclosure. In one embodiment, the GUI 200 may be displayed in a 2.5 dimensional image. In one embodiment, when a user begins a simulation via the GUI 200 a default setting for the game-environment 202 may be displayed. For example, a generic store front, products and customers may be displayed. As a user continues to spend more time interacting with the game-environment 202, more and more features of the game-environment 202 may be customized. For example, the game-environment 202 may be used as an iterative process for the user to continually provide more and more detailed information about the user's business in a “fun” way.

In addition, as the user customizes the features of the game-environment 202, more detailed information may be collected about the business. In other words, the game environment 202 allows detailed information about the business to be collected over time without requiring the business owner to fill out a series of questions. The customizable features of the game-environment 202 are discussed in further detail below.

In another embodiment, the GUI 200 may display a simulation of an operation of the business based upon one or more parameters provided by the user or the business owner. The simulation may reflect store traffic, products sold, size of the business, profits, revenue, and the like.

In one embodiment, the game-environment 202 may have a store front of the business that is fully customizable. For example, the game-environment 202 may have a personalized logo 236 and a store name 238. In addition, the color scheme of the business in the game-environment 202 may be customized to reflect the actual color scheme of the business. The relative size of the business may be customized and reflected in the game-environment 202.

The game-environment 202 may display the actual products 244 and 246 or services sold by the business. It should be noted herein that the term “products” may be used interchangeably with, or also be used to include the term “services.” The game-environment 202 may be customized to specify where the products 244 and 246 are displayed in the store and how the aisles are arranged. Although only two products 244 and 246 are illustrated in the game-environment 202, it should be noted that any number of products or services may be deployed in the game-environment 202.

In one embodiment, the game-environment 202 may include avatars of customers 240 and employees 242. The number of customers 240 may be determined by the simulation based upon the type of marketing campaign and the “typical” customer defined by the user or the business owner. The number of employees 242 may be determined by the simulation based upon the information provided by the user or the business owner.

The game-environment 202 may be animated such that the customers 240 are continually entering and leaving the store at a rate determined by the simulation, strolling through the aisles of the store, examining the products 244 and 246, interacting with the employees 242, and the like. The animation may show the customers 240 selecting a product 244 or 246 and checking out at a register with the employee 242 based upon the customer specifications provided by the user or the business owner.

In one embodiment, the GUI 200 may also include a customization bar 250 that allows a user to easily customize one or more features of the game-environment 202. In one embodiment, the customization bar may include a button for a business specification 204, a product/service specification 206 and a customer specification 208. Although only three buttons are illustrated in the customization bar 250, it should be noted that any number of buttons (e.g., more or less) may be used for customization and additional buttons for other types of customization, e.g., an employee specification, may be used.

In one embodiment, the business specification 204 allows users to customize the store front or type of business they are operating. For example, selecting the button for the business specification 204 may open a menu with one or more predefined templates for different types of businesses. For example, the predefined templates may include a template for a restaurant, a clothing store, an electronics store, an online retailer, a contractor service, a home design service, and the like.

Each template may automatically provide information about one or more parameters associated with the business specification 204. For example, if the user selects a template for a clothing store, the template may automatically define parameters needed for the simulation such as the type of product (e.g., clothes), a brick and mortar store, a typical size of the store, a typical color scheme for the store and the like.

In one embodiment, the template may also have a GUI that allows a user to select one or more parameters. For example, a few color schemes may be presented to the user in the GUI for the template of a clothing store and the user may simply click on the desired color scheme of the store. Different layouts or sizes of a clothing store may be presented to the user in the GUI and the user may simply click on the desired size and layout of the clothing store, and so forth.

In one embodiment, the predefined templates may be presented in levels and sub-levels. For example, the first level may include a size and layout, a second level may include a color scheme, and so forth.

In another example, selecting the button for the business specification 204 may open a pop-up window with a menu or drop down window of customizable features that allows the user to provide information item by item. For example, the user may be able to specify whether the business is a brick and mortar store or a web based store, a size of the store, what types of products or services the store sells, a name of the store, a logo for the store, a color scheme for the store, and the like.

In one embodiment, the product specification 206 allows a user to customize the products and/or services that are sold by the business. For example, selecting the button for the product specification 206 may open a menu with one or more predefined templates for different types of products/services. For example, the predefined templates may include a template for a menu item, an electronics product, an apparel product, a furniture product, an advertising service, a repair service, and the like. Similar to the templates for the different types of businesses, the templates may be presented in a GUI with selectable options.

In another example, selecting the button for the product specification 206 may open a pop-window with a menu or drop down window of customizable features that allows the user to provide information item by item. For example, the user may be able to specify a name of the product and/or the service, a color scheme of a packaging for the product, a minimum and a maximum profit for the product and/or service, a cost of the product and/or the service, a lead-time required to provide the service, an inventory level of the product, profit margin for the product and/or the service, a sales price of the product and/or the service, and the like.

In one embodiment, the customer specification 208 allows a user to customize the “typical” customer that would shop at the business. For example, selecting the button for the customer specification 208 may open a menu with one or more predefined templates for different types of customers. For example, the predefined templates may include templates of a typical male shopper in their 30s, a typical female shopper in their 20s, a typical customer of an electronics store, a typical customer that requires handyman services, and the like. Similar to the templates for the different types of businesses, the templates may be presented in a GUI with selectable options.

In another example, selecting the button for the customer specification 208 may open a pop-window with a menu or drop down window of customizable features that allows the user to provide information item by item. For example, the user may be able to specify a gender of the customer, an age of the customer, an ethnicity of the customer, a secondary characteristic of the customer (e.g., whether they are impulse buyers, window shoppers, economically conscious shoppers, spendthrift shoppers, regular shoppers, etc.), and the like.

In one embodiment, after the simulation begins, the game-environment 202 may make a suggestion to the user for a particular type of marketing campaign based upon the business objective of the user and the one or more parameters provided about the business, products and customers. The user may have the option to accept the suggested marketing campaign or select a different marketing campaign using one or more marketing campaign options via buttons 210, 212 and 214. For example, the button 210 may be a mass mailing marketing campaign, the button 212 may be a promotional sale marketing campaign and the button 214 may be a social network website advertising campaign. Although three buttons for marketing campaigns are illustrated in FIG. 2, it should be noted that any number of buttons may be used depending on the number of marketing campaigns that are available. In addition, although three different types of marketing campaigns are illustrated by example, it should be noted that other types of marketing campaigns may also be used, e.g., PURLs, newspaper advertisements, email campaigns, web-based discount offers, and the like, and are within the scope of the present disclosure.

In one embodiment, the game-environment 202 may be able to make changes on-the-fly when any parameter is changed by the user via the customization bar 250 or any of the marketing campaign buttons 210, 212 and 214. For example, the game-environment 202 may be generated and the simulation may begin based upon initial information and an initial marketing campaign provided by a user. As the simulation is being executed in the game-environment 202, the user may decide to change a product offering via the button 206 for product specification. The game-environment 202 may then instantly display the new product.

In another example, the user may decide to try a different marketing campaign and select the button 212 for a promotional sale marketing campaign. The game-environment 202 may change the simulation on-the-fly to adapt how the change in marketing strategy will affect the profits or revenue generated by the business, for example by animating a higher or a lower number of customers 240 that enter the store, animating an increase or a decrease of customers 240 that make purchases, and the like.

In other words, the game-environment 202 may be dynamically changed on-the-fly by the user to test various parameters or marketing campaigns and the user may immediately see the results of these changes. In stark contrast, the currently used methods are rigid in their approach. Moreover, changing any parameters in the currently used methods may not provide immediate feedback to the user.

In one embodiment, the GUI 200 may also include a metrics dashboard 216. In one embodiment, the metrics dashboard 216 may track various data associated with the simulation in the game-environment 202. For example, the metrics dashboard 216 may include a campaign dashboard 222 that tracks parameters associated with the selected marketing campaign. For example, the campaign dashboard 222 may track a profit 218, a number of customers per hour 220, a cost of a selected marketing campaign 224, a number of people the selected marketing campaign has reached 226, a number of people that have taken an action in response to the selected marketing campaign (e.g., going to the store or to the website) 228, a number of sales due to the selected marketing campaign 230 and revenue 232.

In one embodiment, the metrics tracked by the metrics dashboard 216 may be for a predefined time period, e.g., a week, a month, a year, and the like, and reset after the predefined time period ends. In another embodiment, the metrics tracked by the metrics dashboard 216 may be for a rolling time period, e.g., a week, a month, a year, and the like. in another embodiment, the metrics tracked by the metrics dashboard 216 may be continual over a lifetime of the business. In another embodiment, the metrics tracked by the metrics dashboard 216 may be reset when a new marketing campaign is selected.

In one embodiment, the data collected by the metrics dashboard 216 may be stored to the DB 106. The data may then be used for comparisons or other calculations needed to determine which marketing campaign should be recommended.

After the simulation is executed, the game-environment 202 may recommend a marketing campaign to the user. In one embodiment, the recommendation may be made based upon whether or not the user's business objective is reached. For example, the user's business objective may be to make a profit of $1,000 in a month. The game-environment 202 may simulate the operation of the business given the one or more parameters about the business collected by the game-environment 202 and the selected marketing campaign and determine that the business would generate profit of $1,241 in a month. Thus, the marketing campaign selected for the simulation (e.g., a coupon distribution marketing campaign) may be recommended to the user because the user's business objective is reached.

The user may define any type of business objective they desire. For example, the business objectives may include a revenue or profit objective, a customer awareness objective, a customer conversion objective, a product upselling objective, a customer retention objective, and the like. The metrics dashboard 216 may be used to track various data associated with the business objective to determine if the business objective is met. For example, the revenue 232 may be tracked to determine if the revenue or profit objective is met, the number of people the selected marketing campaign has reached 226 may be used to determine if a customer awareness objective is met, a number of people that have taken an action in response to the selected marketing campaign 228 may be used to determine if the customer conversion objective is met, and the like.

Thus, the embodiments of the present disclosure provide an interactive and fun way for users to provide accurate information about their business and receive a recommendation for a marketing campaign to promote their business. The game-environment provides immediate feedback with respect to changes in profit, revenue, etc., in response to any changes to the business entered by the user.

In one embodiment, the GUI 200 may also have a leaderboard icon 234. In one embodiment, a business may have a plurality of employees compete against one another to see who can find the best marketing campaign using the game-environment 202. Notably, the number of permutations may be very large and having multiple employees compete may provide a way to find the best permutation of parameters to determine the best marketing campaign for the business. The leaderboard icon 234 may illustrate a leaderboard listing all of the users and their respective “score”. In one embodiment, the “score” may simply be the amount of profit generated or the revenue generated based upon an employee's simulation.

In another embodiment, to provide an incentive for the user to spend more time interacting with the game-environment 202, the concept of leveling may be used in the game-environment 202. For example, certain features of the game-environment 202 may be locked until the user “levels up”. Some of the features may be locked until the user “levels up” may include, for example, the ability to add a personalized logo, the ability to use a custom color scheme for the store front, the ability to test certain marketing campaigns, and the like.

In one embodiment, the user may level up based upon performing a predefined number of actions. For example, the user may reach a new level by simulating a predefined number of marketing campaigns, entering a predefined level of information (e.g., answering 75% of the initial questions), generating a predefined level of revenue or profit, playing for a predefined number of hours, and the like.

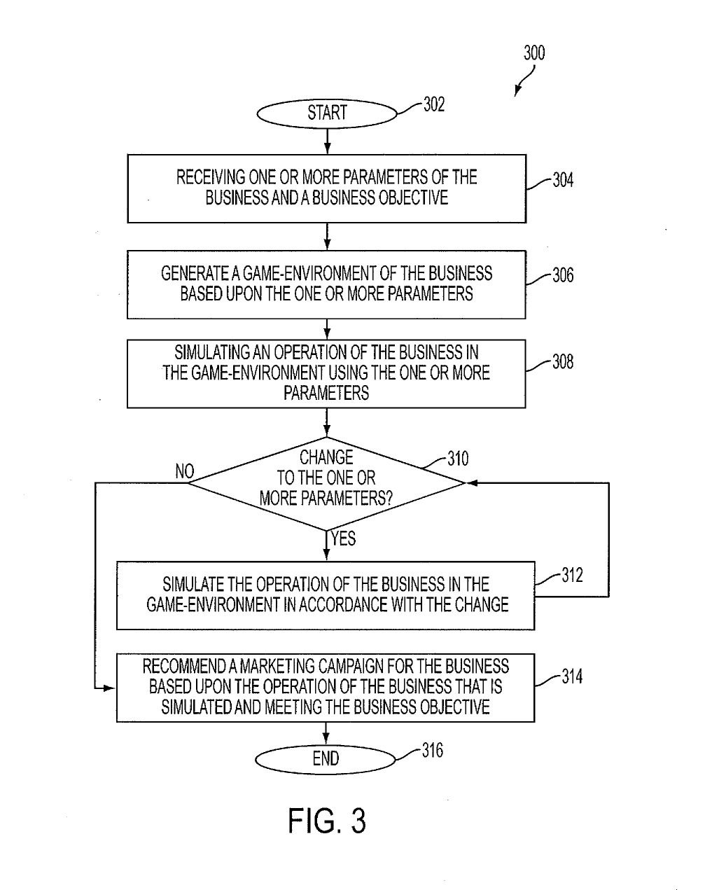

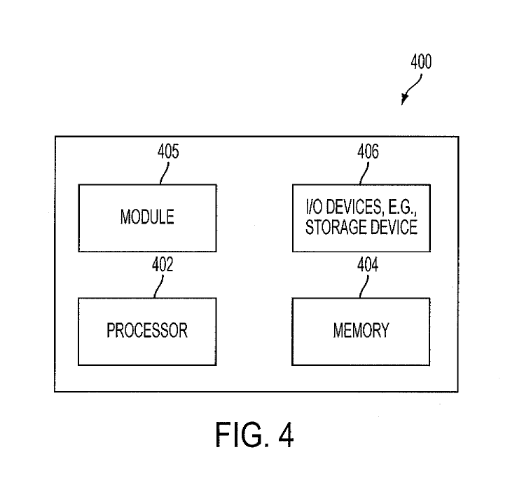

FIG. 3 illustrates a flowchart of a method 300 for recommending a marketing campaign for a business. In one embodiment, the method 300 may be performed by the game server 104 or a general purpose computer as illustrated in FIG. 4 and discussed below.

The method 300 begins at step 302. At step 304, the method 300 receives one or more parameters of the business and a business objective. In one embodiment, the business objective may include a revenue or profit objective, a customer awareness objective, a customer conversion objective, a product upselling objective, a customer retention objective, and the like.

In one embodiment, the one or more parameters may be include a minimal amount of information necessary to generate an initial default game-environment. For example, the information may simply be a type of business. In one embodiment, the one or more parameters may be received initially via a questionnaire, via a tool such as “marketing-in-a-box,” via an initial start up screen of the game-environment 202, using the buttons 204, 206 and 208 of the GUI 200, discussed above, and the like.

At step 306, the method 300 generates a game-environment of the business based upon the one or more parameters. For example, the game-environment may be a 2.5 dimensional animated image as described above with respect to FIG. 2. In one embodiment, the game-environment may start as a default screen that is generic. As the user interacts with the game-environment and logs more hours, more features of the game-environment may be customized by the user, for example, using templates as discussed above. This in turn collects more information from the user about his or her business.

In one embodiment, based upon the one or more parameters and the business objective, the game environment may suggest a particular marketing campaign. The user may have the option to accept the suggested marketing campaign or select another marketing campaign of his or her choice to try and meet the business objective.

At step 308, the method 300 simulates an operation of the business in the game-environment using the one or more parameters. For example, the game-environment may simulate a rate of customers that enter and leave the store based upon modeling data associated with a selected marketing campaign. The modeling data may be used by a simulation engine to simulate other actions such as, for example, how many customers that enter the store will make a purchase, how much profit will be generated, how much revenue will be generated, and the like.

In one embodiment, the simulation may be fully animated such that the user may watch as each action occurs in the game-environment. Certain metric data may be collected and displayed in a metrics dashboard, as discussed above.

In one embodiment, the simulation may be executed for a predefined period of time defined by the user, e.g., a day, a week, a month, a year and the like. In another embodiment, the simulation may run indefinitely until the user instructs the simulation to terminate or until the user selects a different marketing campaign.

At step 310, the method 300 determines if there is a change to the one or more parameters. For example, during the simulation in the game-environment, the user may select to change a product offering of the business, change a cost of the products, select a new marketing campaign, and the like.

At step 310, if no change is detected, the method 300 may proceed to step 314. However, if at step 310 a change is detected, the method 300 may proceed to step 312.

At step 312, the method 300 simulates the operation of the business in the game-environment in accordance with the change. For example, if the user decides to add a new product, the new product would appear in the game-environment. In another example, if the user decides to change a sales price of a product, the profit and revenue data would adjust accordingly. In another example, if the user selects a new marketing campaign, the game-environment may change the number of customers that enter and leave the store, the number of purchases made and the corresponding metrics in the metrics dashboard.

The method 300 returns to step 310 to determine if any additional changes are detected. If no further changes are detected at step 310, the method 300 proceeds to step 314.

At step 314, the method 300 recommends a marketing campaign for the business based upon the operation of the business that is simulated and meeting the business objective. The method ends at step 316.

It should be noted that although not explicitly specified, one or more steps of the method 300 described above may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in FIG. 3 that recite a determining operation, or involve a decision, do not necessarily require that both branches of the determining operation be practiced. In other words, one of the branches of the determining operation can be deemed as an optional step.

FIG. 4 depicts a high-level block diagram of a general-purpose computer suitable for use in performing the functions described herein. As depicted in FIG. 4, the system 400 comprises a processor element 402 (e.g., a CPU), a memory 404, e.g., random access memory (RAM) and/or read only memory (ROM), a module 405 for recommending a marketing campaign for a business, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present disclosure can be implemented in software and/or in a combination of software and hardware, e.g., using application specific integrated circuits (ASIC), a general purpose computer or any other hardware equivalents, e.g., computer readable instructions pertaining to the method(s) discussed above can be used to configure a hardware processor to perform the steps of the above disclosed methods. In one embodiment, the present module or process 405 for recommending a marketing campaign for a business can be loaded into memory 404 and executed by processor 402 to implement the functions as discussed above. As such, the present method 405 for recommending a marketing campaign for a business (including associated data structures) of the present disclosure can be stored on a non-transitory computer readable storage medium, e.g., RAM memory, magnetic or optical drive or diskette and the like. For example, the hardware processor 402 can be programmed or configured with instructions (e.g., computer readable instructions) to perform the steps of method 300.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method for recommending a marketing campaign for a business, comprising:
receiving one or more parameters of the business and a business objective;
generating a game-environment of the business based upon the one or more parameters;
simulating an operation of the business in the game-environment using the one or more parameters; and
recommending the marketing campaign for the business based upon the operation of the business that is simulated and meeting the business objective.

2. The method of claim 1, wherein the one or more parameters comprise: a business specification, a product specification, a service specification or a customer specification.

3. The method of claim 2, wherein the business specification includes information comprising a type of business or a size of the business.

4. The method of claim 2, wherein the product specification or the service specification includes information comprising a cost of manufacturing a product, an inventory level of the product, a sales price of the product, a lead-time for the product, a cost of providing a service, a level of the service, a sales price of the service, or a lead-time for the service.

5. The method of claim 2, wherein the customer specification includes information comprising an age of a customer, a gender of the customer, an ethnicity of the customer or a secondary characteristic of the customer.

6. The method of claim 1, wherein the business objective comprises a revenue objective, a customer awareness objective, a customer conversion objective, a product upselling objective or a customer retention objective.

7. The method of claim 1, further comprising:
receiving a change to the one or more parameters of the business during the simulating of the operation of the business; and
simulating the operation of the business in the game-environment in accordance with the change.

8. The method of claim 1, wherein the game-environment comprises a leaderboard of a plurality of employees of the business who is competing in the game-environment.

9. The method of claim 1, wherein one or more features of the game-environment are unlocked when a new level is achieved.

10. The method of claim 9, wherein the new level is achieved when a predefined number of marketing campaigns is simulated, when a predefined level of information is received or when a predefined dollar amount of revenue is earned.

11. A non-transitory computer-readable medium having stored thereon a plurality of instructions, the plurality of instructions including instructions which, when executed by a processor, cause the processor to perform a method for recommending a marketing campaign for a business, comprising:
receiving one or more parameters of the business and a business objective;
generating a game-environment of the business based upon the one or more parameters;
simulating an operation of the business in the game-environment using the one or more parameters; and
recommending the marketing campaign for the business based upon the operation of the business that is simulated and meeting the business objective.

12. The non-transitory computer-readable medium of claim 11, wherein the one or more parameters comprise: a business specification, a product specification, a service specification or a customer specification.

13. The non-transitory computer-readable medium of claim 12, wherein the business specification includes information comprising a type of business or a size of the business.

14. The non-transitory computer-readable medium of claim 12, wherein the product specification or the service specification includes information comprising a cost of manufacturing a product, an inventory level of the product, a sales price of the product, a lead-time for the product, a cost of providing a service, a level of the service, a sales price of the service, or a lead-time for the service.

15. The non-transitory computer-readable medium of claim 12, wherein the customer specification includes information comprising an age of a customer, a gender of the customer, an ethnicity of the customer or a secondary characteristic of the customer.

16. The non-transitory computer-readable medium of claim 11, wherein the business objective comprises a revenue objective, a customer awareness objective, a customer conversion objective, a product upselling objective or a customer retention objective.

17. The non-transitory computer-readable medium of claim 11, further comprising:
receiving a change to the one or more parameters of the business during the simulating of the operation of the business; and
simulating the operation of the business in the game-environment in accordance with the change.

18. The non-transitory computer-readable medium of claim 11, wherein the game-environment comprises a leaderboard of a plurality of employees of the business who is competing in the game-environment.

19. The non-transitory computer-readable medium of claim 11, wherein one or more features of the game-environment are unlocked when a new level is achieved.

20. A method for recommending a marketing campaign for a business, comprising:
receiving one or more parameters and a business objective from a user, wherein the one or more parameters comprise a business type, a product or a service sold by the business and a description of a customer;
generating a game-environment of the business based upon the business type, the product or the service sold by the business and the description of the customer;
simulating an operation of the business in the game-environment using the business type, the product or the service sold by the business and the description of the customer;
suggesting a marketing campaign in accordance with the one or more parameters and the business objective;
simulating the operation of the business in the game-environment in accordance with the marketing campaign;
determining if the business objective is met using the marketing campaign based upon the simulating of the operation of the business in the game-environment in accordance with the marketing campaign; and
recommending the marketing campaign for the business if the business objective is met.
